(19) United States
(12) Patent Application Publication
(10) Pub. No.: US 2018/0278920 A1
(43) Pub. Date: Sep. 27, 2018

(54) ENTERTAINMENT APPARATUS FOR A SELF-DRIVING MOTOR VEHICLE

(71) Applicant: Ford Global Technologies, LLC, Dearborn, MI (US)

(72) Inventor: Frederic STEFAN, Aachen (DE)

(73) Assignee: Ford Global Technologies, LLC, Dearborn, MI (US)

(21) Appl. No.: 15/928,022

(22) Filed: Mar. 21, 2018

(30) Foreign Application Priority Data
Mar. 27, 2017 (DE) 10 2017 205 079.9

(51) Int. Cl. H04N 13/30

(52) U.S. Cl. CPC H04N 13/30; B60R 11/0229

(57) ABSTRACT

The disclosure relates to an entertainment apparatus for a self-driving motor vehicle. The entertainment apparatus is designed to use a plurality of interior surfaces in an interior of the motor vehicle as reproduction surfaces for image data. A module is configured to, in response to an evaluation of dynamic parameters while driving, transfer image data from image data sets to a plurality of interior surfaces in a vehicle interior to reproduce the image data such that the dynamic parameters are coordinated with the image data on each of the interior surfaces.

### CROSS-REFERENCE TO RELATED APPLICATIONS

This application claims foreign priority benefits under 35 U.S.C. § 119(a)-(d) to DE Application 10 2017 205 079.9 filed Mar. 27, 2017, which is hereby incorporated by reference in its entirety.

### TECHNICAL FIELD

The disclosure relates to an entertainment apparatus for a self-driving motor vehicle.

### BACKGROUND

A self-driving motor vehicle is understood to be a motor vehicle that can drive, steer and park without the intervention of a human driver (highly automated driving or autonomous driving). The term robot car is also used in cases where no manual control on the part of the driver is necessary. The driver's seat can then remain empty; steering wheel, brake and accelerator pedal may not even be present.

The term “self-driving motor vehicle” also includes trucks, agricultural tractors and military vehicles that drive without the intervention of the driver, or even without a driver at all. If an unmanned motor vehicle has to be remotely controlled by a human being, i.e. it cannot drive autonomously, it is not an autonomous land vehicle.

Autonomous motor vehicles can detect their surroundings with the aid of a variety of sensors and can determine their position and that of other road users from the information obtained, can drive to a destination through cooperation with the navigation software, and can avoid collisions on the way.

Through this development towards self-driving motor vehicles, motor vehicles will change into mobility platforms that are no longer controlled by a driver. This leads to a complete redesign of the interior of the motor vehicle. In addition to this, the fact that the driver is no longer forced to concentrate on driving means that he has much more “free time”, especially during longer trips.

### SUMMARY

It is therefore the object of the disclosure to indicate ways in which the driver can use this new free time.

The object of the disclosure is achieved through an entertainment apparatus for a self-driving motor vehicle that is designed to use a plurality of interior surfaces in an interior of the motor vehicle as reproduction surfaces for image data. These interior surfaces can thus be used to reproduce image data from films or computer games.

According to one embodiment, one of the interior surfaces is designed as a screen. The screen can, for example, be designed as a flat screen, e.g. an OLED screen, and can have a curved form adapted to the interior space.

According to a further embodiment, the entertainment apparatus comprises a projector that projects image data onto one of the interior surfaces. The interior surface can thus itself remain unchanged.

According to a further embodiment, one of the interior surfaces is designed as a window surface of the motor vehicle. A surface that is relatively flat in comparison with other surfaces in the interior of a motor vehicle can thus be used.

According to a further embodiment, one of the interior surfaces is designed as a roof lining of the motor vehicle. The roof lining can thus also be used as a reproduction surface.

According to a further embodiment, the entertainment apparatus is designed to use the plurality of interior surfaces to reproduce image data of an image data set and/or of a plurality of image data from image data sets. It is thus possible—e.g. when reproducing image data of a computer game—to extend a reproduction over a plurality of reproduction surfaces to convey a 3-D impression, or a progress of a game surrounding the players. The interior surfaces can also, alternatively, be used so that each passenger can watch his own individual film or can play his own individual computer game.

According to a further embodiment, the entertainment apparatus is designed to output 2-D and/or 3-D image data sets as image data. In contrast to 2-D image data, 3-D image data here means that a reproduction thereof conveys a moving image with an impression of depth for stereoscopic vision to the observer through a stereoscopic method.

According to a further embodiment, the entertainment apparatus is designed to output 4-D image data sets as image data. In contrast to 3-D image data, 4-D image data here means that yet further operations are employed during the reproduction thereof in order to increase the completeness of the illusion, e.g. through the following special effects:

fragrances are introduced into the cinema room,

artificial rain and/or fog are produced,

wind is generated, and

so-called leg-ticklers (usually plastic threads) rotate under the cinema seats. They are intended to imitate grass, moving insects or similar.

According to a further embodiment, the entertainment apparatus is designed to control a ventilation and/or air-conditioning device of the motor vehicle in order to implement this additional data during reproduction.

According to a further embodiment, the entertainment apparatus is designed to output 5-D image data sets as image data. In contrast to 4-D image data, 5-D image data here means that, during a reproduction thereof, as further special effects, seats, or entire groups of observer seats are moved or vibrate in order to raise the completeness of the illusion even further.

According to a further embodiment, the entertainment apparatus is designed to control a seat adjustment device of a seat of the motor vehicle in order to implement this additional data during reproduction.

According to a further embodiment, the entertainment apparatus is designed to evaluate driving dynamic parameters of the motor vehicle and to take them into account in the reproduction of image data. The illusion of movements can thus be raised yet further through vehicle movement.

A computer program product and a motor vehicle with such an entertainment apparatus also belong to the disclosure. The entertainment apparatus may be a microprocessor, or controller.

The disclosure will now be explained with reference to a drawing, in which:

### BRIEF DESCRIPTION OF THE DRAWINGS

FIG. 1 shows a schematic illustration of a motor vehicle with an entertainment apparatus according to one exemplary embodiment;

FIG. 2 shows a schematic illustration of components of the entertainment apparatus;

FIG. 3 shows a schematic illustration of components assigned to the entertainment apparatus; and

FIG. 4 shows a schematic illustration of an apparatus that detects and evaluates driving dynamic parameters of the motor vehicle.

### DETAILED DESCRIPTION

As required, detailed embodiments of the present disclosure are disclosed herein; however, it is to be understood that the disclosed embodiments are merely exemplary of the disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

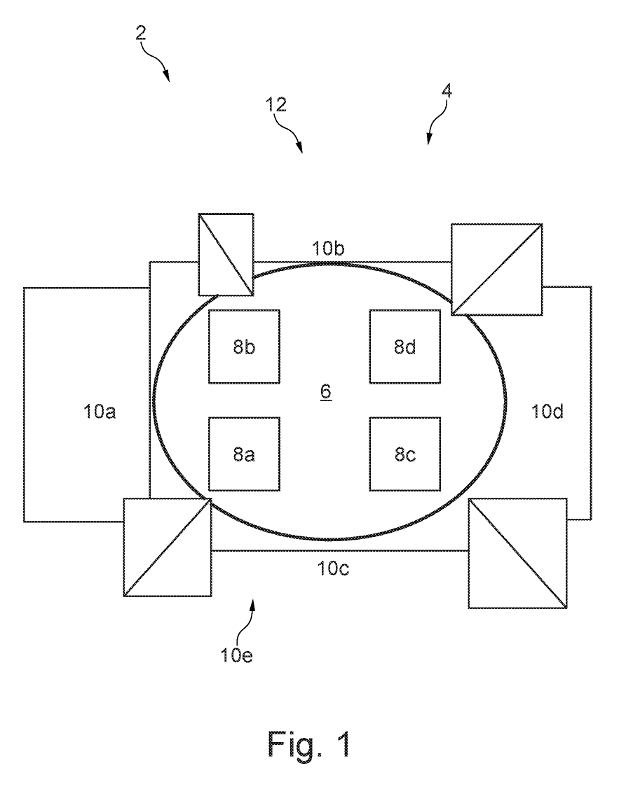

Reference is first made to FIG. 1.

A self-driving vehicle 2, which in the present exemplary embodiment takes the form of an automobile, is illustrated. Differing from the present exemplary embodiment, the motor vehicle 2 can also take the form of a truck.

A self-driving motor 2 vehicle is understood here to be a motor vehicle that can drive, steer and park without intervention of a human driver (highly automated driving or autonomous driving). A driver's seat (not shown) can then remain empty, and a steering wheel, and brake and accelerator pedals may not even be present.

The self-driving motor vehicle 2 can detect its surroundings with the aid of a variety of sensors (not illustrated), determine a position of the vehicle 2 and that of other road users from the information obtained, drive to a destination through cooperation with navigation software, and avoid collisions on a route to the destination.

Four seats 8a, 8b, 8c, 8d for passengers are provided in an interior 6 of the motor vehicle 2 in the present exemplary embodiment. An entertainment apparatus 4 is designed to use a plurality of interior surfaces 10a, 10b, 10c, 10d, 10e as displays 12 in the interior 6 of the motor vehicle 2 as reproduction surfaces for image data provided in the interior 6.

For this purpose, the entertainment apparatus 4 in the present exemplary embodiment comprises one or a plurality of projectors (not illustrated) with which image data can be projected onto one or all of the interior surfaces 10a, 10b, 10c, 10d, 10e. Alternatively, one or all of the interior surfaces 10a, 10b, 10c, 10d, 10e can each be designed as a screen, e.g. as an OLED screen.

In the present exemplary embodiment, the interior surfaces 10a, 10b, 10c, 10d are window surfaces of the motor vehicle 2, such as for example a windshield, a rear window and side windows. Depending on a presence of A, B or C pillars, a number of side windows can vary from the present exemplary embodiment. A further interior surface 10e is designed as a roof liner of the motor vehicle 2.

With the entertainment apparatus 4, an image data set can optionally be reproduced on the plurality of interior surfaces 10a, 10b, 10c, 10d, 10e. The entertainment apparatus 4 is also designed to reproduce a plurality of image data sets on each of the interior surfaces 10a, 10b, 10c, 10d, 10e.

The entertainment apparatus 4 is furthermore designed in the present exemplary embodiment to output 2-D and/or 3-D and/or 4-D and/or 5-D image data sets as image data.

For this purpose, it is possible—as will be explained later in more detail—for the entertainment apparatus 4 to be designed to operate ventilation and/or air-conditioning devices 34 (not illustrated in FIG. 1) of the motor vehicle 2 and/or seat adjustment devices 42 (not illustrated in FIG. 1) of the seats 8a, 8b, 8c, 8d of the motor vehicle 2.

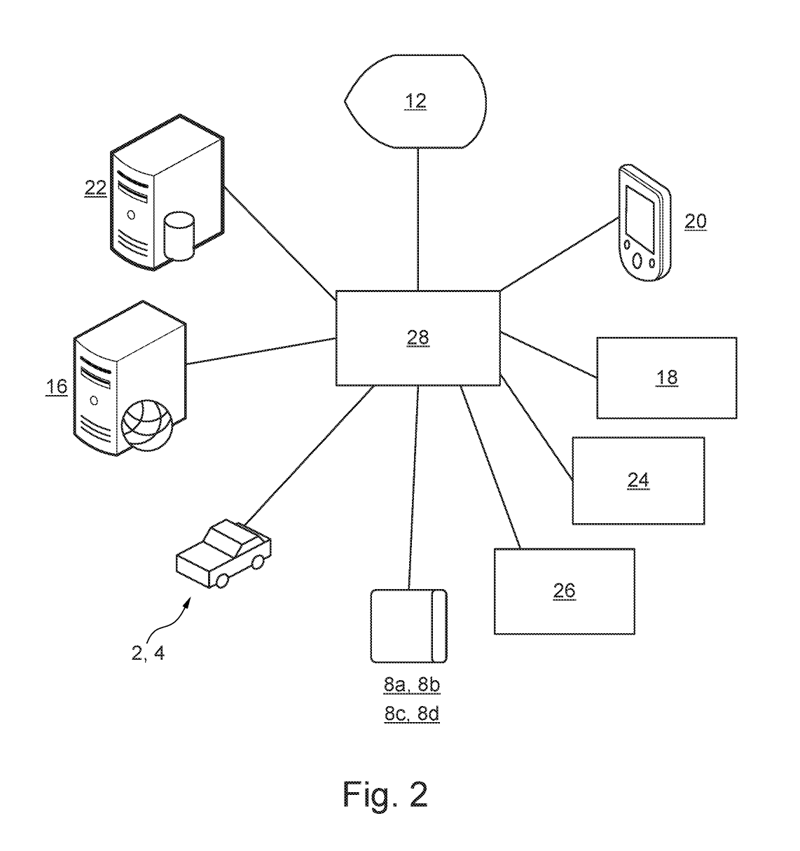

Reference is now additionally made to FIG. 2.

The entertainment apparatus 4 comprises, in the present exemplary embodiment, the following components: an entertainment module 16, a communication module 18, a human-machine interface 20, a cloud server 22, a 4-D image data reproduction module 24, a 5-D image data reproduction module 26 and a coordination module 28.

The entertainment apparatus 4, and also the entertainment module 16, the communication module 18, the human-machine interface 20, the cloud server 22, the 4-D image data reproduction module 24, the 5-D image data reproduction module 26 and/or the coordination module 28 can comprise hardware such as a microprocessor and/or software component in order to execute their functions as described below.

The entertainment module 16 is designed to transfer image data of a film or of a computer game to reproduction devices such as a screen or projectors.

The entertainment module 16 can, furthermore, contain a collection of films and/or computer games that have been downloaded by passengers before, or during, a trip that can be used while driving. The entertainment module 16 can, furthermore, comprise a video streaming function in order to reproduce one of a plurality of films on the display 12, while all the films are archived on the cloud server 22. The entertainment module 16 can also act as a game client for a computer game on the cloud server 22.

The communication module 18 in the present exemplary embodiment is designed for wireless communication (e.g. 4G or 5G) between the entertainment module 16 and the cloud server 22 (e.g. fiber optics, Ethernet . . . ) and the seats 8a, 8b, 8c, 8d.

The human-machine interface 20 is designed such that, in operation, a film and/or a computer game can be selected and controlled by the passengers. The human-machine interface 20 can be a mobile part that is implemented in the respective seat 8a, 8b, 8c, 8d. Alternatively, the human-machine interface 20 can be a smartphone of a passenger that is connectable via an interface to the entertainment apparatus 4 (e.g. via SYNC, wireless, plug, Bluetooth . . . ). The human-machine interface 20 can be integrated into a virtual environment or comprise so-called smart glasses (wearable computers that project information into the visual field of the user) or so-called 3-D glasses. Haptic elements, e.g. haptic gloves, can furthermore be assigned to the human-machine interface 20.

The cloud server 22 can be a remotely arranged server that the entertainment apparatus 4 can access in order to download films or computer games before, or during, a journey, possibly, for example, via the communication module 18, in order to establish a streaming connection to the cloud server 22 or to establish a connection as a game client.

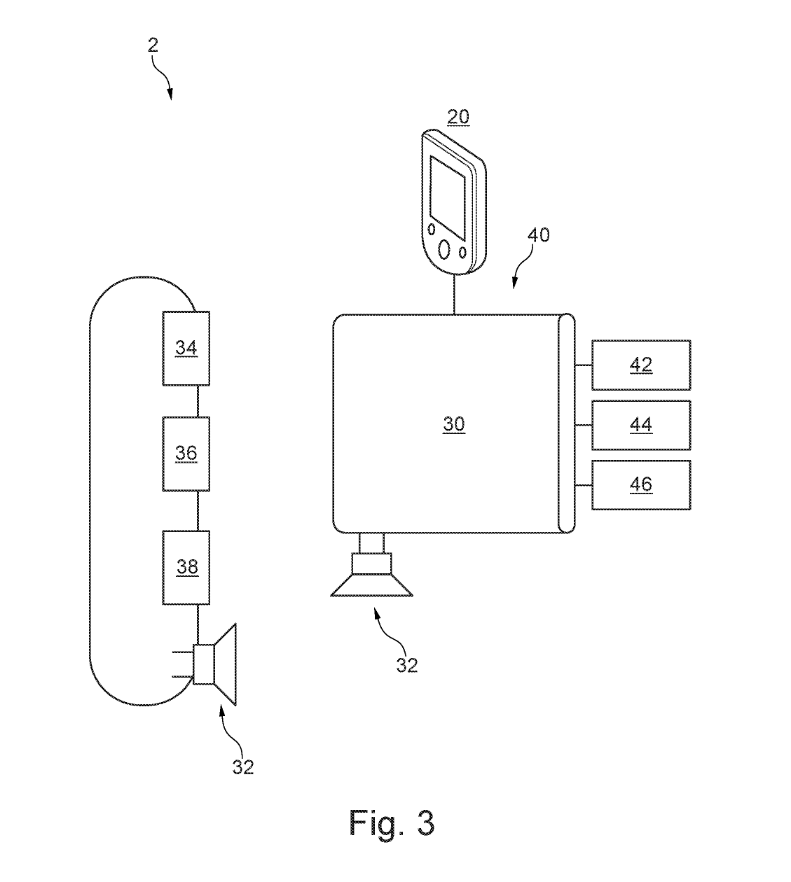

The 4-D image data reproduction module 24 can comprise software and/or a controller, and will be explained later with additional reference to FIG. 3.

The 5-D image data reproduction module 26 is designed to coordinate a degree of movement of the seats 8a, 8b, 8c, 8d with particular scenes of a film/computer game. This can be done through an arbitrary combination of vehicle movements (particular longitudinal/transverse movement of the vehicle); vehicle maneuvers that are performed by the motor vehicle for this purpose, or through special maneuvers independent of traffic.

The coordination module 28 is designed to coordinate and control of the overall system. For example, two passengers in the front seats 8a, 8b want to watch a 4-D film during the trip, while the passengers in the rear seats 8c, 8d want to play a motor racing game.

Reference is now additionally made to FIG. 3.

The instrument panel (not illustrated) is also considered to belong to the seats 8a, 8b, 8c, 8d. In the present exemplary embodiment, the seats 8a, 8b, 8c, 8d comprise a sitting surface 30, loudspeakers 32, a ventilation and/or air-conditioning device 34, a fragrance generator 36, a water droplet generator 38, an interface 40 for connection of the human-machine interface 20, a seat adjusting device 42, a seat rotation device 44, and a seat acceleration device 46.

The seats 8a, 8b, 8c, 8d, along with the loudspeakers 32, the ventilation and/or air-conditioning device 34, the fragrance generator 36, the water droplet generator 38, the interface 40, the seat adjusting device 42, the seat rotation device 44 and/or the seat acceleration device 46 can comprise hardware and/or software components in order to execute their functions as described below.

The loudspeakers 32 can be arranged in the environment or in a seat backrest. The loudspeaker 32, which can comprise groups of individual loudspeakers, is designed here to implement a surround-effect or 3-D sound. The loudspeaker 32 can be accessible via an audio plug in the respective seat 8a, 8b, 8c, 8d, which can be particularly useful when a plurality of passengers would like to use the entertainment apparatus 4 for different purposes at the same time.

The ventilation and/or air-conditioning device 34 can be controlled by the 4-D image data reproduction module 24 in order in this way to implement 4-D effects. The fragrance generator 36 which, together with the ventilation and/or air-conditioning device 34, implements 4-D effects, can be a fragrance generator that is designed to implement an ambient fragrance or to implement countermeasures to bad odors.

The water droplet generator 38 is used together with the fragrance generator 36 and the ventilation and/or air-conditioning device 34 in order to implement 4-D effects.

The 4-D image data reproduction module 24 can drive the ventilation and/or air-conditioning device 34, the fragrance generator 36 and the water droplet generator 38 in order to generate weather effects.

A flow of air can thus be generated with the 4-D image data reproduction module 24 if, for example, a person in a film scene moves quickly or is exposed to wind. Fragrances can, furthermore, be generated if a person is exposed to an odor. Water droplets can, furthermore, be generated if, for example, a person in a film scene is exposed to rain and/or air moisture. The 4-D image data reproduction module 24 can be activated when a 3-D game or film is selected by a passenger.

Services can, furthermore, be offered to the passengers via the interface 40 and a human-machine interface 20 connected through it.

The seat adjusting device 42 is designed to adjust a sitting position with respect to the virtual display or for reproduction of 5-D image data.

The seat rotation device 44, furthermore, is provided to create the sitting position with reference to the virtual display for the reproduction of 5-D image data.

The seat acceleration device 46, furthermore, is designed for the simulation of G-forces.

Alternatively or in addition, the seat adjusting devices 42, the seat rotation device 44 and/or the seat acceleration device 46 can be driven by the 5-D image data reproduction module 26. At a beginning of the journey, the passengers enter the system through their respective human-machine interfaces 20. After downloading the 4-D film and the motor racing game, the entertainment apparatus 4 configures the display 12 such that the two passengers in the front seats 8a, 8b see the 4-D film, while the passengers in the rear seats 8c, 8d can play the motor racing game. The internal surface 10c and the internal surface 10d can here each be used in a divided manner, so that part of the interior surfaces 10b, 10c is assigned to the front seats 8a, 8b and the other part to the rear seats 8c, 8d.

The ventilation and/or air-conditioning device 34, the fragrance generator 36 and the water droplet generator 38 may furthermore be driven, if appropriate, by the 4-D image data reproduction module 24.

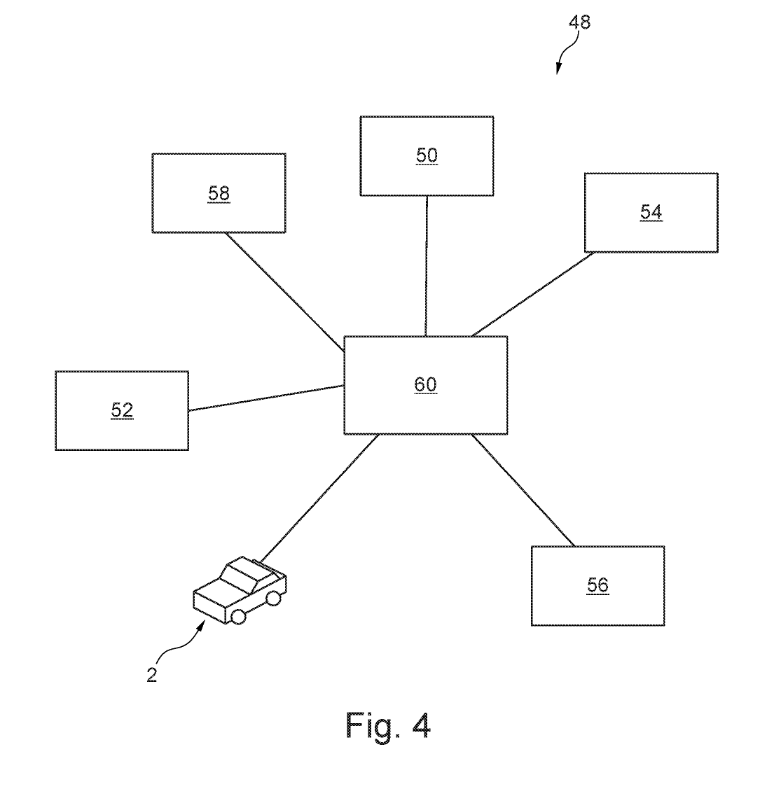

Reference is additionally made to FIG. 4.

The apparatus 48 illustrated in FIG. 4 detects and evaluates driving dynamic parameters of the motor vehicle 2, such as, for example speeds, accelerations and torques that act along a longitudinal, transverse and/or vertical axis of the motor vehicle 2. The apparatus 48 also detects a profile of a drive path such as climbs, drops and/or curves. The apparatus 48 furthermore detects environmental conditions such as, for example, weather and wind, traffic conditions such as traffic density, traffic jams, start-stop traffic, and other road users.

These parameters can be determined and evaluated by vehicle sensors (camera, lidar, radar . . . ), by cloud data (weather, traffic . . . ), by navigation data (GPS, map . . . ) or through prediction algorithms (big data, predictive analytics . . . ).

In operation, the apparatus 48 works in two operating modes.

In the first operating mode, the entertainment program that is made available to the passengers depends on external parameters. This means that the apparatus 48 only provides those entertainment offerings (game, film) for which additional effects can be implemented, bearing in mind the values of the external parameters. For example, the apparatus 48 will preselect a part of a film or of a computer game for which a route to be driven and traffic conditions allow it to generate an appropriate acceleration and/or deceleration. This operating mode can be used when the driver has selected this operating mode, the motor vehicle 2 has been started and is moving, a specific route to be driven has been selected, traffic density is below a limiting value, the specific route exhibits a certain distribution of drops/climbs, other road users are located outside a predetermined region surrounding the motor vehicle 2, weather conditions are good and an expected energy consumption for effects related to the specific route lie below a threshold value.

If, on the other hand, some of these conditions are not met, the effects are not implemented.

In the second operating mode, the apparatus 48 is designed to influence a few external parameters in order to implement effects. This means that the apparatus 48 is designed to choose a particular driving route, determine a trajectory and implement driving maneuvers.

This operating mode can be used when the driver has selected the second operating mode, the motor vehicle 2 is at the beginning of a trip and no specific route to be driven has been selected, an alternative route is available for selection that will not bring a delay, the traffic density is below a limiting value, other road users are located outside a predetermined region surrounding the motor vehicle 2, weather conditions are good and an expected energy consumption for the effects lies below a threshold value.

If, on the other hand, some of these conditions are not met, the effects are not implemented.

The apparatus 48 comprises a driving dynamic monitoring device 50, a calculation unit 52, an effect determination unit 54, a vehicle movement control unit 56, a maneuver monitoring unit 58 and an entertainment management unit 60.

For the execution of their functions as described below, the apparatus 48, together with the driving dynamic monitoring device 50, the calculation unit 52, the effect determination unit 54, the vehicle movement control unit 56, the maneuver monitoring unit 58 and/or the entertainment management unit 60 can comprise hardware and/or software components.

The driving dynamic monitoring device 50 detects driving dynamic parameters of the motor vehicle 2 such as, for example, speeds, accelerations and torques. The driving dynamic monitoring device 50 also monitors a profile of a drive path such as climbs, drops and curves. The driving dynamic monitoring device 50 furthermore detects environmental conditions such as, for example, weather and wind, traffic conditions such as traffic density, traffic jams, start-stop traffic, and other road users.

On the basis of values detected by the driving dynamic monitoring device 50, an effect determination unit 54 determines the effects that can be implemented, and which cannot. This is done before the entertainment apparatus 4 starts up, and can be repeated continuously during operation of the entertainment apparatus 4.

The vehicle movement control unit 56 is designed to determine a type and time of effects that should be implemented for a selected entertainment program. Suitable time points can be marked by the vehicle movement control unit 56.

The maneuver monitoring unit 58 is designed to implement maneuvers of the motor vehicle 2 through specification of driving variables such as acceleration and/or torques. The maneuver monitoring unit 58 can have access to vehicle control components for this purpose. Control signals from the maneuver monitoring unit 58 here have a lower priority than control signals from other vehicle components, in order to guarantee traffic safety.

The maneuver monitoring unit 58 is designed to implement a particular effect through a driving maneuver. The effects are converted for this purpose into drive parameters in that, for example, a table, a regulator, a Kalman filter etc. is used and the drive parameters are transferred to the maneuver monitoring unit 58. The maneuver monitoring unit 58 also uses information from the driving dynamic monitoring device 50 in order to check whether or not the external conditions allow the effects to be implemented. No effects are implemented in the presence of a traffic jam, for example.

It can, further, be provided that effects are only implemented in a weakened form if the parameters allowed this and implementation of the effects with full strength is not possible.

It can, further, be provided that an energy requirement or consumption for the effect generation is determined. A decision to implement the effects or not can be made on the basis of a current energy reserve. The deactivation, i.e. a non-implementation of effects can also be provided, in order in this way to reduce the energy consumption and, potentially, emissions from the motor vehicle 2.

It can, in addition, be provided that, in planning a route to be traveled, a selected piece of entertainment such as a film is borne in mind in order to be able to implement effects with maximum effect by taking external parameters that will result from driving along this route into account.

The entertainment management unit 60 coordinates all said components, i.e. the driving dynamic monitoring device 50, the calculation unit 52, the effect determination unit 54, the vehicle movement control unit 56 and the maneuver monitoring unit 58. The entertainment management unit 60 furthermore monitors which effects should be implemented, and whether the current route and current traffic conditions allow them to be implemented through driving maneuvers, requests the implementation of the effects by the vehicle movement control unit 56, and monitors this.

In this way it is possible to use the interior surfaces 10a, 10b, 10c, 10d, 10e in the interior 6 of the motor vehicle 2 in order to reproduce image data of films or computer games.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

What is claimed is:

1. An entertainment apparatus for a self-driving motor vehicle comprising:
a module configured to, in response to an evaluation of dynamic parameters while driving, transfer image data from image data sets to a plurality of interior surfaces in a vehicle interior to reproduce the image data such that the dynamic parameters are coordinated with the image data on each of the interior surfaces.

2. The entertainment apparatus as claimed in claim 1, wherein one of the interior surfaces is designed as a screen.

3. The entertainment apparatus as claimed in claim 1 further comprising a projector that projects the image data onto one of the interior surfaces.

4. The entertainment apparatus as claimed in claim 1, wherein one of the interior surfaces is designed as a window.

5. The entertainment apparatus as claimed in claim 1, wherein one of the interior surfaces is designed as a roof liner.

6. The entertainment apparatus as claimed in claim 1, wherein the module is designed to use the plurality of interior surfaces to reproduce a plurality of image data from the image data sets.

7. The entertainment apparatus as claimed in claim 1, wherein the module is designed to output 3-D image data sets as image data.

8. The entertainment apparatus as claimed in claim 1, wherein the module is designed to output 4-D image data sets as image data.

9. The entertainment apparatus as claimed in claim 8, wherein the module is designed to operate a ventilation and/or air-conditioning device to output image data indicative of the 4-D image data sets.

10. The entertainment apparatus as claimed in claim 9, wherein the module is designed to output 5-D image data sets as image data.

11. The entertainment apparatus as claimed in claim 10, wherein the module is designed to operate a seat adjusting device of a seat to output image data indicative of the 5-D image data sets.

12. An autonomous vehicle comprising:
an entertainment module designed to use a plurality of interior surfaces in a vehicle interior to reproduce image data derived from image data sets selected from a human-machine interface;
a cloud server communicable, via a communication module, with the entertainment apparatus to download the image data sets during a trip having dynamic parameters based on the trip;
a 4-D reproduction module designed to, in response to the image data being indicative of air flow, control an air conditioning device to represent the air flow;
a 5-D reproduction module designed to, in response to the image data being indicative of a degree of vehicle movement, coordinate a degree of seat movement to represent the degree of vehicle movement; and
a coordination module designed to, in response to the image data, coordinate control of the 4-D and 5-D reproduction modules during the trip with the dynamic parameters.

13. The autonomous vehicle as claimed in claim 12, wherein the entertainment module is designed to use the plurality of interior surfaces to reproduce a plurality of image data from the image data sets.

14. The autonomous vehicle as claimed in claim 12, wherein one of the interior surfaces is a roof liner.

15. The autonomous vehicle as claimed in claim 12, wherein one of the interior surfaces is a window.

16. The autonomous vehicle as claimed in claim 12, wherein one of the interior surfaces is a screen.

17. A self-driving vehicle entertainment apparatus comprising:
a module configured to, in response to an evaluation of dynamic parameters while driving, reproduce image data from image data sets to a plurality of interior surfaces in a vehicle interior such that the dynamic parameters are coordinated with the image data.

18. The self-driving vehicle entertainment apparatus as claimed in claim 17, wherein the module is designed to use the plurality of interior surfaces to reproduce a plurality of image data from the image data sets.

19. The self-driving vehicle entertainment apparatus as claimed in claim 18, wherein the module is designed to operate a ventilation and/or air-conditioning device to output image data from the plurality of image data being indicative of 4-D image data sets.

20. The self-driving vehicle entertainment apparatus as claimed in claim 19, wherein the module is designed to operate a seat adjusting device of a seat to output image data from the plurality of image data being indicative of 5-D image data sets.
